(19) United States
(12) Patent Application Publication
(10) Pub. No.: US 2021/0252734 A1
(43) Pub. Date: Aug. 19, 2021

(54) Hand-Guided Treatment Device with Electric Drive Motor

(71) Applicant: Andreas Stihl AG & Co. KG, Waiblingen (DE)

(72) Inventor: Georg HEINZELMANN, Winnenden (DE)

(21) Appl. No.: 17/175,342

(22) Filed: Feb. 12, 2021

(30) Foreign Application Priority Data
Feb. 14, 2020 (EP) 20157308.6

(51) Int. Cl. B27B 17/12; B27B 17/02; B24B 23/02; F04D 13/06; F04D 29/043; F04D 29/60

(52) U.S. Cl. CPC B27B 17/12; B27B 17/02; F04D 29/605; F04D 13/06; F04D 29/043; B24B 23/02

(57) ABSTRACT

A hand-guided treatment device has a motor housing, a retaining body arranged in a side region of the motor housing for holding a guide element protruding from the motor housing for a treatment tool which rotates or circulates around the guide element, and an electric drive motor arranged in the motor housing for driving the treatment tool. The drive motor includes a drive shaft with a tool drive region passing through the retaining body, and a rotor held rotationally fixedly on the drive shaft. A lubricant pump drive is coupled to a lubricant pump drive region of the drive shaft for driving a lubricant pump arranged in the motor housing for supplying lubricant to the treatment tool. The lubricant pump drive region and the tool drive region of the drive shaft are arranged on opposite sides of the rotor.

### CROSS REFERENCE TO RELATED APPLICATION

This application claims priority under 35 U.S.C. § 119 from European Patent Application No. 20157308.6, filed Feb. 14, 2021, the entire disclosure of which is herein expressly incorporated by reference.

### BACKGROUND AND SUMMARY OF THE INVENTION

The invention is directed to a hand-guided treatment device comprising a motor housing, a retaining body which is arranged in a side region of the motor housing and may in particular be configured as a retaining plate to hold a guide element protruding from the motor housing for a treatment tool which rotates or circulates around the guide element, and an electric drive motor arranged in the motor housing for driving the treatment tool. Such devices are common for example in the gardening and forestry sectors, and the construction and Do-It-Yourself (DIY) sectors. In particular, in corresponding embodiments of the invention, the device may be configured as a power saw or cutting grinder.

The drive motor may have a drive shaft, in particular with a tool drive region passing through the retaining body, and a rotor held rotationally fixedly on the drive shaft. The drive motor may comprise a stator carrier on which a stator of the drive motor is held rotationally fixedly, and through which the drive shaft may extend and/or on which the drive shaft may be mounted by means of a motor bearing.

The retaining body may e.g. be a cantilever body which has a region on the motor housing side and a region protruding from the motor housing for holding the treatment tool so as to be rotationally movable. In the cantilever body, a tool coupling element may be arranged rotationally fixedly on the tool drive region of the drive shaft for coupling the treatment tool to the drive shaft.

According to one aspect of the invention, the treatment device comprises a lubricant pump drive coupled to a lubricant pump drive region of the drive shaft for driving a lubricant pump arranged in the motor housing for supplying lubricant, e.g. lubricating oil, to the treatment tool, for which the lubricant pump drive may comprise for example a lubricant pump coupling element that is arranged rotationally fixedly on a lubricant pump drive region of the drive shaft.

The treatment device may for example be configured as a power saw, in which the retaining body comprises, as a region on the motor housing side, a rail fixing plate for external fixing of a guide rail, as a region protruding from the motor housing, for holding a saw chain so as to be rotationally movable in circulation as a treatment tool. Accordingly, in this case, the tool drive region forms a chain drive region, and the tool coupling element forms a chain coupling element.

Power saws of this type are mainly used as so-called cordless or battery-operated saws, in which the electric drive motor is powered by an accumulator battery preferably arranged on or in the motor housing; these are for example produced and sold by the applicant in various designs, both as a so-called rear handle type with a main handle arranged on a rear of the motor housing, and as a so-called top handle type with a main handle arranged on a top of the motor housing. By means of the lubricant pump drive, the drive motor, which also drives the saw chain, drives a lubricant pump, by means of which the lubricant can be conveyed from a lubricant tank to the rail fixing plate and hence to the saw chain. The stator carrier of the drive motor is usually pre-produced as a sleeve-like component which carries a stator/motor structure of the drive motor and is held via a flange on an inside of the rail fixing plate by means of screw connections.

In these conventional power saws, the lubricant pump drive region of the drive shaft, on which the lubricant pump coupling element is arranged, is usually provided between the rotor or stator and the chain drive region on which the chain coupling element is arranged for coupling the saw chain to the drive shaft. This positioning of the lubricant pump coupling element allows the lengths of the lubricant lines, which are required for transporting lubricant from a lubricant tank via the lubricant pump to the rail fixing plate, to be kept relatively short.

A hand-guided treatment device of the type cited initially, in the form of a power saw in which, in the manner outlined above, the lubricant pump drive region is situated between the chain drive region and the stator or rotor, and the stator carrier pre-fabricated as a sleeve-like component is held on the rail fixing plate, is disclosed in laid-open publication DE 10 2010 033 489 A1. In particular, there a lubricant pump pinion engages with a pot-like worm gear wheel which, at its pot edge, is held rotationally fixedly on the base of a pot-like brake drum that itself sits rotationally fixedly on the drive shaft.

Patent publication JP 6266304 B2 discloses a jigsaw with a reciprocating saw tool which is driven by a drive motor, wherein its stator/rotor structure is held on a sleeve-like carrier part protruding from an inner housing body in which a gear mechanism is arranged that acts between the drive motor and the saw tool.

The invention is based on the technical problem of providing a hand-guided treatment device of the type disclosed initially which, in comparison with the above-mentioned prior art, has advantageous technical innovations, in particular with respect to the positional configuration of the lubricant pump drive and/or with respect to the connection of the drive motor to the motor housing.

The invention solves this problem by providing a hand-guided treatment device with specific novel, advantageous features as compared to the prior art mentioned above.

According to one aspect of the invention, the treatment device comprises a motor housing, a retaining body arranged in a side region of the motor housing for holding a guide element protruding from the motor housing for a treatment tool which rotates or circulates around the guide element, an electric drive motor arranged in the motor housing for driving the treatment tool, wherein the drive motor comprises a drive shaft with a tool drive region passing through the retaining body, and a rotor held rotationally fixedly on the drive shaft, and a lubricant pump drive coupled to a lubricant pump drive region of the drive shaft for driving a lubricant pump arranged in the motor housing for supplying lubricant to the treatment tool. Characteristically, the lubricant pump drive region and the tool drive region of the drive shaft are arranged on opposite sides of the rotor. In this embodiment, the treatment device may in particular be a power saw.

In comparison with the conventional positioning of the lubricant pump coupling element between the rotor or stator and the tool drive region of the drive shaft, and hence on a side of the rotor/stator of the electric drive motor facing outward, this means a relocation to the side of the rotor/stator facing away from the tool drive region of the drive shaft and inward from the motor housing. This does not follow the conventional aim of placing the lubricant pump coupling element on the drive shaft in a region which allows minimal lubricant line lengths, but unexpectedly it has been found that this measure allows other advantages to be achieved which may be of greater importance in many applications.

So with this selection according to the invention of the lubricant pump drive region of the drive shaft on the rotor/stator side of the drive motor facing away from the tool drive region of the drive shaft, the drive shaft may be shortened in comparison with conventional designs, and the actual structure of the drive motor, i.e. its stator and rotor structure, may lie closer to the tool drive region than with said conventional designs in which the lubricant pump drive region lies between this stator/rotor structure and the tool drive region. The smaller distance of the stator/rotor structure from the tool drive region offers advantages with respect to the centre of gravity of the device and hence for its handling. In particular, the relocation of the stator/motor structure towards the tool drive region of the drive shaft draws the centre of gravity of the drive motor back closer to the longitudinal centre axis of the device, which may make it easier for the user to pivot the device during use.

As a further advantage, if necessary, for mounting the drive motor in power saws a motor bearing with a main bearing may be provided which may be arranged with significantly shorter distance from the tool drive region than in conventional power saws, which can significantly reduce the force loading. In particular, force moment loads which result from transverse forces on the guide rail of the saw chain may be reduced. Because of the lower force loading, designs with reduced weight may be used for the drive shaft and stator carrier, such as a drive shaft with smaller shaft diameter and/or a smaller stator carrier, which contributes to a low overall weight of the power saw.

In a refinement of the invention, the lubricant pump drive region is situated on a face end portion of the drive shaft inside the motor housing. This means positioning a lubricant pump coupling element of the lubricant pump drive on the inner face end of the drive shaft, and hence as far away as possible from the tool drive region on the opposite shaft end. In alternative embodiments, the lubricant pump drive region is situated between the rotor and this face end portion of the drive shaft on the inside of the motor housing.

In a refinement of the invention, the power saw has a ventilator fan with a fan wheel which can be driven by the drive motor and is arranged coaxially to the drive shaft, wherein the lubricant pump drive region is situated on a side of the fan wheel facing away from the rotor, or a lubricant pump coupling element of the lubricant pump drive is formed integrally with the fan wheel. In this refinement, the drive motor also serves to drive the ventilator fan, wherein the fan wheel may be formed integrally with the rotor or placed close to the rotor, in particular between the rotor and the lubricant pump drive region. If necessary, the fan wheel and the lubricant pump coupling element are formed from the same component. This may save installation space and help achieve a shorter installation length for the drive shaft. In alternative embodiments, the lubricant pump drive region is situated between the rotor and the fan wheel.

In a refinement of the invention, the power saw has a support device between a lubricant pump housing and the drive shaft, wherein the support device contains a bearingless support portion of the lubricant pump housing or a pump housing bearing unit. With this support device, depending on need and application, the lubricant pump housing may be supported exclusively or additionally on the drive shaft, or the drive shaft may be guided or mounted additionally by the lubricant pump housing which is then designed sufficiently stiff. In alternative embodiments, such a support device is omitted and the lubricant pump housing is then connected to or rests solely on other components in the motor housing.

In one embodiment of the invention, the power saw has a lubricant pump housing bracket which holds the lubricant pump housing on the motor housing or on a component rigidly connected to the motor housing. This constitutes an advantageous embodiment for an optional additional support of the lubricant pump housing directly or indirectly on the motor housing.

In a refinement of the invention, a brake drum with pot-like cross-section is arranged rotationally fixedly on the drive shaft axially between the rotor and the tool drive region, and a motor bearing for the drive shaft has a bearing unit which partially or completely overlaps with the brake drum. This design advantageously allows the provision of a mechanical brake for the drive motor, while simultaneously achieving a design of drive motor structure which is compact in the axial direction. This is supported by the pot-like cross-section of the brake drum and the axial overlap of the bearing unit for the drive shaft with the brake drum. The axial overlap is complete or partial depending on design and requirements. In the former case, the bearing unit lies completely within the axial installation height, i.e. the pot depth, of the brake drum; in the latter case, the bearing unit extends in the axial direction partially inside and for the remainder outside the axial extent of the brake drum. In alternative embodiments, there is no brake drum or in any case no axial overlap of a bearing unit for the drive shaft with a brake drum.

Also, in this embodiment, despite the presence of the mechanical brake, the bearing unit can be positioned with a relatively small distance from the tool drive region of the drive shaft, which is favourable with respect to the absorption of occurring force loads. Alternatively, other mountings are possible, e.g. by means of two bearing components on the inside of the cantilever fixing part.

According to a further aspect of the invention, the treatment device comprises a motor housing, a retaining body arranged in a side region of the motor housing with a region on the outside of the motor housing which is configured for holding a guide element protruding from the motor housing for a treatment tool which rotates or circulates around the guide element, and an electric drive motor arranged in the motor housing for driving the treatment tool, wherein the drive motor comprises a stator carrier and a drive shaft passing through the retaining body. Characteristically, the stator carrier is formed integrally with a region of the retaining body inside the motor housing.

This one-piece design of stator carrier and region of the retaining body inside the motor housing allows a corresponding reduction in the number of components for the treatment device, and a corresponding reduction in the mounting complexity. Since this design omits connecting means between the stator carrier and the rail fixing plate, there is no need to ensure sufficient strength and desired force transmission behavior for these connecting means.

In a refinement of the invention, the treatment device is configured as a power saw and the retaining body is formed as a cantilever body in the form of a rail fixing plate which is configured for externally fixing a guide rail as a guide element for holding a saw chain so as to be rotationally movable in circulation as a treatment tool. Alternatively, the treatment tool may be configured e.g. as a cutting grinder. In this case, the retaining body is a cantilever body which accommodates a belt drive or similar for torque transmission from the drive shaft to a tool shaft which is offset parallel thereto, and about which the treatment tool rotates in this case.

In a refinement of the invention, the retaining body is made from a bend-resistant plastic material or metal material. This provides advantageous material embodiments for the retaining body.

In a refinement of the invention, the retaining body is a magnesium casting. This constitutes an advantageous design for the retaining body with respect to adequate strength and low weight. In alternative embodiments, the retaining body is formed from another metallic material or a preferably fibre-reinforced plastic material.

In a refinement of the invention, a stator of the drive motor is held pressed onto the stator carrier. This constitutes a favourable fixing of the stator to the stator carrier with respect to strength and mounting complexity. Alternatively, the stator may be held rotationally fixedly on the stator carrier in another conventional fashion, e.g. by means of a screw or bonded connection.

In a refinement of the invention, a motor bearing of the drive motor comprises at least one bearing unit on each of an inside and an outside of the retaining body. In corresponding applications, this constitutes a favorable support of the drive motor on both sides of the retaining body.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an excerpt from a longitudinal sectional view of a part of a power saw of interest here, with integral design of rail fixing plate and stator carrier, and with a drive shaft with tool drive region and lubricant pump drive region on a side of a stator of an electric drive motor facing away from the tool drive region,

FIG. 2 shows a sectional view corresponding to FIG. 1 for a variant with respect to the mounting of the drive shaft and coupling of a lubricant pump drive to the lubricant pump drive region,

FIG. 3 shows a schematic perspective view of a lubricant pump drive side of the embodiment variant of FIG. 2,

FIG. 4 shows a sectional view corresponding to FIG. 1 for a further embodiment variant,

FIG. 5 shows a sectional view corresponding to FIG. 1 for yet a further variant with external instead of internal stator of the drive motor,

FIG. 6 shows a perspective view of a lubricant pump drive side of the variant from FIG. 5,

FIG. 7 shows a sectional view similar to FIG. 1 with isolated depiction of the drive motor and with stator carrier formed integrally with a region of the retaining body on the motor housing side, and

FIG. 8 shows a sectional view corresponding to FIG. 7 for a modified embodiment variant.

### DETAILED DESCRIPTION OF THE DRAWINGS

The hand-guided treatment device, depicted in each case only in a region of interest in the present case, in the various exemplary embodiments shown in the figures, is configured as an electric power saw, but in alternative embodiments may accordingly be configured as a cutting grinder or another hand-guided device, in particular from the gardening and forestry sector or the building and DIY sector, that is equipped with corresponding device components.

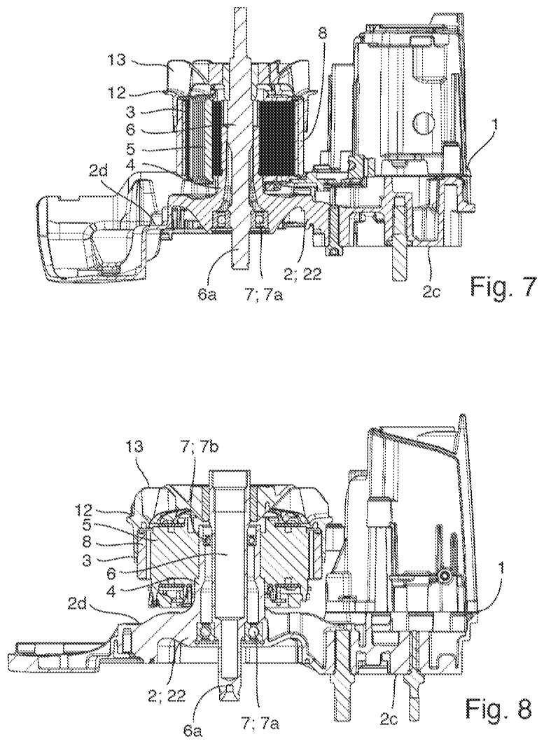

The hand-guided treatment device in the embodiment shown in FIGS. 1 to 8 comprises a motor housing 1 and a retaining body 2 arranged in a side region of the motor housing 1. In each of the views shown in FIGS. 1, 2, 4, 5, 7 and 8, this side region of the motor housing 1 points downward. The retaining body 2 is configured to retain a guide element protruding from the motor housing 1 for a treatment tool which rotates or circulates around the guide element. In the case of a power saw, the treatment tool is a saw chain which circulates around a guide rail functioning as a guide element. In the case of a cutting grinder, the retaining body forms a cantilever body which protrudes from the motor housing 1, comprises a mounting for a rotating cutting disc, and receives a rotation-transmitting member e.g. in the form of a circulating drive belt.

In corresponding embodiments, the retaining body 2, as in the examples shown, holds the guide element for the treatment tool on a region 2c on the outside of the motor housing.

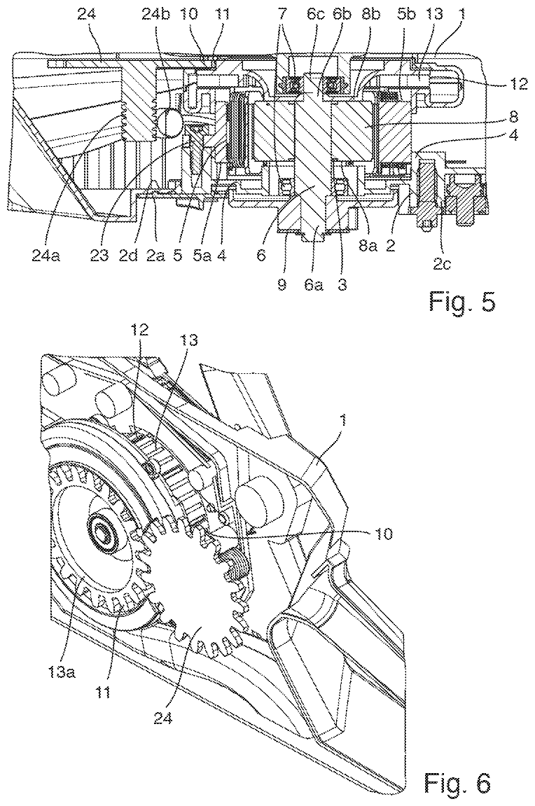

Furthermore, the treatment device comprises an electric drive motor 3 arranged in the motor housing 1 for driving the treatment tool, wherein the drive motor 3 has a drive shaft 6 passing through the retaining body 2. Both designs with external rotor, as in the examples of FIGS. 1 to 4, 7 and 8, and those with internal rotor, as in the examples of FIGS. 5 and 6, are suitable for the drive motor 3.

In advantageous embodiments, as in the examples shown, the drive motor 3 contains a stator carrier 4 which is formed integrally with the region 2d of the retaining body 2 on the inside of the motor housing. In alternative embodiments, the drive motor 3 may contain a stator carrier which is pre-fabricated separately from the retaining body 2 and then attached e.g. to the retaining body.

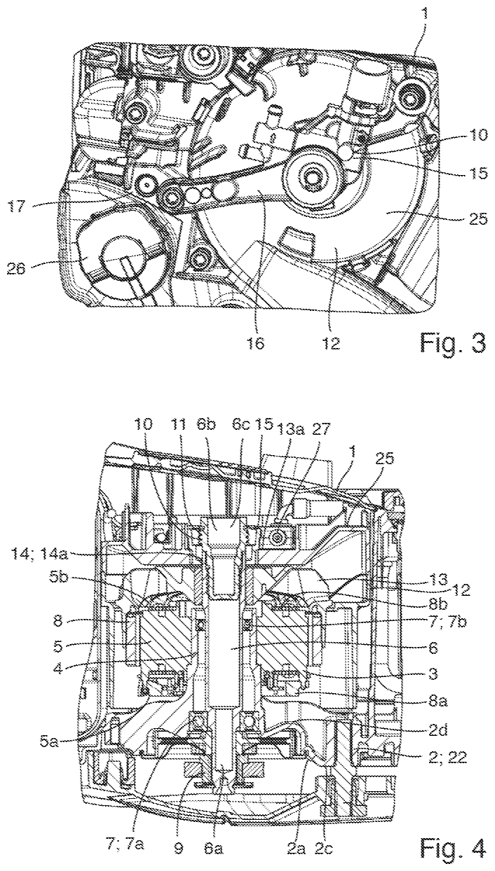

In advantageous embodiments, the treatment device furthermore contains a lubricant pump drive 10 coupled to a lubricant pump drive region 6b of the drive shaft 6, for driving a lubricant pump arranged in the motor housing 1 for supplying lubricant to the treatment tool. The lubricant may, as known in itself, be stored in a lubricant tank 26, as evident for example in FIGS. 1 and 3. The lubricant pump drive region 6b and a tool drive region 6a of the drive shaft 6, which passes through the retaining body 2, are situated on opposite sides 8a, 8b of a rotor 8 of the drive motor 3 which is held rotationally fixedly on the drive shaft 6. In the examples shown in this respect, the lubricant pump drive region 6b is also situated on a side 5b of a stator 5 of the drive motor 3 opposite the tool drive region 6a. The lubricant may for example be a lubricating oil or another lubricating fluid for the saw chain of a power saw. In the case of a power saw, the tool drive region 6a constitutes a chain drive region on which a chain coupling element 9, also called a sprocket, is rotationally fixedly arranged for coupling the saw chain to the motor shaft 6.

In corresponding embodiments, the lubricant pump drive region 6b is situated on a face end portion 6c of the drive shaft 6 on the inside of the motor housing, as clearly evident for example from FIGS. 1, 2 and 4. In alternative embodiments, no lubricant pump drive is provided for the treatment tool, or the lubricant pump drive region 6b and the tool drive region 6a are situated on a same side of the rotor 8.

In embodiments as a power saw, the retaining body 2, as in the examples shown, typically contains a rail fixing plate 22 which is configured for fixing the guide rail as a guide element for holding the saw chain so as to be rotationally movable in circulation as a treatment tool. Here, the retaining body may as a whole be formed by the rail fixing plate 22, or alternatively comprise one or more further retaining body regions.

In structurally advantageous embodiments, the retaining body 2 is made from a metal material or a bend-resistant plastic material. For example, the retaining body 2 may be a magnesium casting produced in a magnesium diecasting process.

In corresponding embodiments, a stator 5 of the drive motor 3 is held pressed onto the stator carrier 4. In addition or alternatively, the stator 5 may be held on the stator carrier 4 by the use of a further or other connecting means, e.g. by screw connections 23 as shown in FIG. 5.

In corresponding embodiments, the drive motor 3 contains a motor bearing 7 which comprises at least one bearing unit 7a, 7b on each of an inside 2b and an outside 2a of the retaining body 2. Thus the drive shaft 6 may be mounted on both sides of the retaining body 2 in a manner favorable for many applications, as implemented for example in the embodiment shown in FIG. 1.

In advantageous embodiments, the treatment device also contains a ventilator fan 12 with a fan wheel 13, which can be driven by the drive motor 3 and is arranged coaxially to the drive shaft 6, wherein the lubricant pump drive region 6b is situated on a side 13a of the fan wheel 13 facing away from the rotor 8, as shown in the examples of FIGS. 1 to 4; or a lubricant pump coupling element 11 of the lubricant pump drive 10 is formed integrally with the fan wheel 13, as in the example of FIGS. 5 and 6.

In particular, in the exemplary embodiment of FIGS. 5 and 6, the lubricant pump drive 10 forms a gear mechanism with a gear wheel 24 which firstly has an external toothed ring, via which it is in engagement with the lubricant pump coupling element 11 formed as a corresponding toothed ring on the side 13a of the fan wheel 13 facing away from the rotor, and secondly via a worm gear wheel 24a cooperates with a pump-side pinion which is indicated merely schematically by means of a spacer 24b. This design has the advantage that the lubricant pump can be positioned relatively close to the lubricant tank 26. Also, the axial installation length of the motor structure of the drive motor 3 in this case remains unaffected by the axial length of the worm gear wheel 24a of the lubricant pump drive 10.

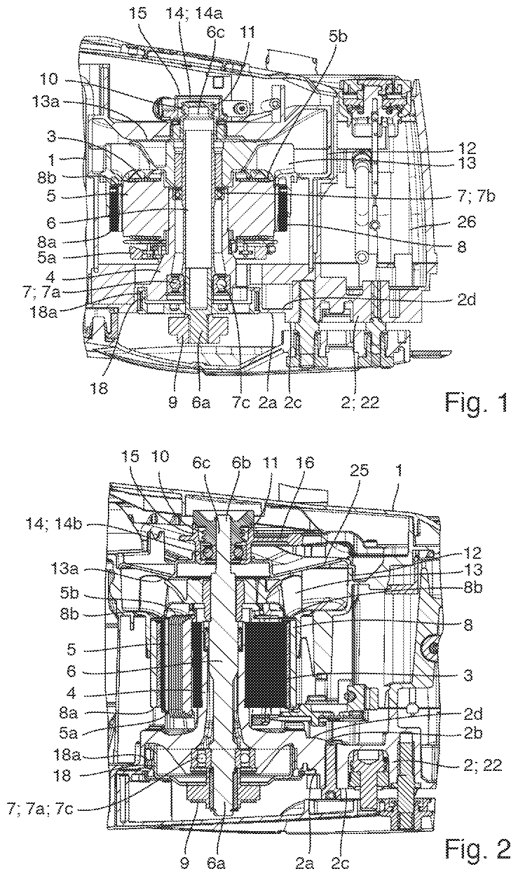

In advantageous embodiments, the treatment device comprises a support device 14 between a lubricant pump housing 15 and the drive shaft 6. For this, the support device 14 contains for example a bearingless support portion 14a of the lubricant pump housing 15, as in the exemplary embodiments of FIGS. 1 and 4, or a pump housing bearing unit 14b as in the exemplary embodiment of FIGS. 2 and 3. In the examples shown, the lubricant pump housing 15 is supported on the drive shaft 6 by means of the support device 14. In alternative embodiments, the support device 14 is selected such that it supports the drive shaft 6 on the lubricant pump housing 15. In the latter case, the lubricant pump housing 15 is configured and arranged with correspondingly high stability.

In corresponding embodiments, the treatment tool contains a lubricant pump housing bracket 16 which holds the lubricant pump housing 15 on the motor housing 1 or on a component 17 which is rigidly connected to the motor housing 1. In the exemplary embodiment of FIGS. 2 and 3, the lubricant pump housing bracket 16 is a holding arm which is attached to a wall structure rigidly connected to the motor housing 1, and extends radially and at a slight axial distance from a fan housing 25 of the ventilator fan 12. This component 17 may e.g. be the lubricant tank 26 if this is constructed in a correspondingly stable fashion, as an example of FIGS. 2 and 3, e.g. as a magnesium diecasting.

The holding arm formed by this design of the lubricant pump housing bracket 16 allows stable support of the lubricant pump housing 15 on the motor housing 1 or the stable component 17, so that the lubricant pump housing 15 can itself be constructed with relatively low weight and need not absorb large forces from the drive train. The fan housing 25 in this case may also be designed so as to be very slender or lightweight, and serves merely to fulfil the function of a fan air guide.

In the exemplary embodiment of FIG. 4, the fan housing 25 is designed so as to be significantly stiffer and hence more stable than in the example of FIGS. 2 and 3, which in this case allows a lubricant pump structure 27 containing the lubricant pump, or the lubricant pump housing 15, to be held on the fan housing 25. The same is preferably provided in the exemplary embodiment of FIG. 1.

In advantageous embodiments, a brake drum 18 with a pot-like cross-section is arranged rotationally fixedly on the drive shaft 6 of the drive motor 3, axially between the rotor 8 and the tool drive region 6a, wherein the motor bearing 7 for the drive shaft 6 has a bearing unit 7c overlapping axially with the brake drum 18, as implemented in the examples of FIGS. 1 to 4. The bearing unit 7c here overlaps completely with the axial extent of the brake drum 18 in the example of FIG. 2, and only partially in the examples of FIGS. 1 and 4.

The overlap allows a particularly short axial structure for the drive shaft 6 or the overall structure of the drive motor 3, while simultaneously providing the mechanical braking effect by the brake drum 18. For this mechanical braking effect, the brake drum 18 may be provided e.g. with a brake lining 18a arranged on the outside of its casing surface, such as in the form of a peripheral brake band. In corresponding embodiments, such as the examples shown in this respect, the bearing unit 7c overlapping with the brake drum 18 may at the same time form the bearing unit 7a on the outside 2a of the retaining body 2.

As clearly indicated by the exemplary embodiments shown and explained in detail above, the invention provides an advantageous hand-guided treatment tool with electric drive motor, motor housing and retaining body arranged at the side thereof for a treatment tool which can be driven by the drive motor, in which a stator carrier for a stator of the drive motor is formed integrally with a region of the retaining body on the inside of the motor housing, and/or a lubricant pump drive region and a tool drive region of the drive shaft of the drive motor are situated on opposite sides of a rotor of the drive motor.

The arrangement of the lubricant pump drive on the rotor side opposite the tool coupling to the drive shaft offers various advantages, such as shortening a distance from the main bearing of the drive shaft and the drive pinion for the tool, and thereby reducing transverse forces on the pinion, which then with otherwise constant conditions allows a smaller diameter and shorter axial length of the drive shaft, and because of the lower load a smaller structure of the stator carrier with associated significant weight reduction. The stator/rotor structure of the drive motor may be positioned at a relatively small axial distance from the tool coupling on the drive shaft, whereby the center of gravity of the drive motor can be brought relatively close to a longitudinal center axis of the device, which may facilitate handling and in particular pivotability of the treatment device for the user. The one-piece design of the stator carrier with the retaining body for the tool contributes to minimizing the number of components required and stabilizing the connection of the drive motor firstly and treatment tool secondly on the retaining body.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hand-guided treatment device, comprising:
a motor housing;
a retaining body arranged in a side region of the motor housing for holding a guide element protruding from the motor housing for a treatment tool which rotates or circulates around the guide element;
an electric drive motor arranged in the motor housing for driving the treatment tool, wherein the drive motor comprises a drive shaft with a tool drive region passing through the retaining body, and a rotor held rotationally fixedly on the drive shaft; and
a lubricant pump drive coupled to a lubricant pump drive region of the drive shaft for driving a lubricant pump arranged in the motor housing for supplying lubricant to the treatment tool, wherein
the lubricant pump drive region and the tool drive region of the drive shaft are arranged on opposite sides of the rotor.

2. The hand-guided treatment device according to claim 1, wherein
the lubricant pump drive region is situated on a face end portion of the drive shaft inside the motor housing.

3. The hand-guided treatment device according to claim 1, further comprising:
a ventilator fan with a fan wheel capable of being driven by the drive motor and arranged coaxially to the drive shaft, wherein
the lubricant pump drive region is situated on a side of the fan wheel facing away from the rotor, or a lubricant pump coupling element of the lubricant pump drive is formed integrally with the fan wheel.

4. The hand-guided treatment device according to claim 1, further comprising:
a support device between a lubricant pump housing and the drive shaft, wherein
the support device contains a bearingless support portion of the lubricant pump housing or a pump housing bearing unit.

5. The hand-guided treatment device according to claim 1, further comprising:
a lubricant pump housing bracket which holds the lubricant pump housing on the motor housing or on a component rigidly connected to the motor housing.

6. The hand-guided treatment device according to claim 1, further comprising:
a brake drum with pot-shaped cross-section that is arranged rotationally fixedly on the drive shaft axially between the rotor and the tool drive region; and
a motor bearing for the drive shaft that comprises a bearing unit which overlaps axially with the brake drum.

7. A hand-guided treatment device, comprising:
a motor housing;
a retaining body arranged in a side region of the motor housing with a region on the outside of the motor housing which is configured for holding a guide element protruding from the motor housing for a treatment tool which rotates or circulates around the guide element; and
an electric drive motor arranged in the motor housing for driving the treatment tool, wherein
the drive motor comprises a stator carrier and a drive shaft passing through the retaining body, and
the stator carrier is formed integrally with a region of the retaining body inside the motor housing.

8. The hand-guided treatment device according to claim 7, wherein
the device is configured as a power saw and the retaining body contains a rail fixing plate, which is configured for fixing a guide rail as a guide element in order to hold a saw chain so as to be rotationally movable in circulation as a treatment tool.

9. The hand-guided treatment device according to claim 7, wherein
the retaining body is made from a bend-resistant plastic material or metal material.

10. The hand-guided treatment device according to claim 9, wherein
the retaining body is a magnesium casting.

11. The hand-guided treatment device according to claim 7, wherein
a stator of the drive motor is held pressed onto the stator carrier.

12. The hand-guided treatment device according to claim 7, wherein
a motor bearing of the drive motor comprises at least one bearing unit on each of an inside and an outside of the retaining body.

13. The hand-guided treatment device according to claim 7, further comprising:
a lubricant pump drive coupled to a lubricant pump drive region of the drive shaft for driving a lubricant pump arranged in the motor housing for supplying lubricant to the treatment tool, wherein
the drive shaft comprises a tool drive region passing through the retaining body,
a rotor of the drive motor is held rotationally fixedly on the drive shaft, and
the lubricant pump drive region and the tool drive region of the drive shaft are arranged on opposite sides of the rotor.

14. The hand-guided treatment device according to claim 13, wherein
the lubricant pump drive region is situated on a face end portion of the drive shaft inside the motor housing.

15. The hand-guided treatment device according to claim 13, further comprising:
a ventilator fan with a fan wheel capable of being driven by the drive motor and arranged coaxially to the drive shaft, wherein
the lubricant pump drive region is situated on a side of the fan wheel facing away from the rotor, or a lubricant pump coupling element of the lubricant pump drive is formed integrally with the fan wheel.

16. The hand-guided treatment device according to claim 13, further comprising:
a support device between a lubricant pump housing and the drive shaft, wherein
the support device contains a bearingless support portion of the lubricant pump housing or a pump housing bearing unit.

17. The hand-guided treatment device according to claim 13, further comprising:
a lubricant pump housing bracket which holds the lubricant pump housing on the motor housing or on a component rigidly connected to the motor housing.

18. The hand-guided treatment device according to claim 13, further comprising:
a brake drum with pot-shaped cross-section that is arranged rotationally fixedly on the drive shaft axially between the rotor and the tool drive region; and
a motor bearing for the drive shaft that comprises a bearing unit which overlaps axially with the brake drum.
